(19) United States
(12) Patent Application Publication
(10) Pub. No.: US 2015/0179170 A1
(43) Pub. Date: Jun. 25, 2015

(54) Discriminative Policy Training for Dialog Systems

(71) Applicant: Microsoft Corporation, Redmond, WA (US)

(72) Inventors: Ruhi Sarikaya, Redmond, WA (US); Daniel Boies, Saint-Lambert, (CA)

(73) Assignee: Microsoft Corporation, Redmond, WA (US)

(21) Appl. No.: 14/136,575

(22) Filed: Dec. 20, 2013

(51) Int. Cl. G10L 15/22

(52) U.S. Cl. CPC G10L 15/22

(57) ABSTRACT

Embodiments of a dialog system employing a discriminative action selection solution based on a trainable machine action model. The discriminative machine action selection solution includes a training stage that builds the discriminative model-based policy and a decoding stage that uses the discriminative model-based policy to predict the machine action that best matches the dialog state. Data from an existing dialog session is annotated with a dialog state and an action assigned to the dialog state. The labeled data is used to train the discriminative model-based policy. The discriminative model-based policy becomes the policy for the dialog system used to select the machine action for a given dialog state.

### BACKGROUND

Spoken dialog systems respond to commands from a user by estimating the intent of the utterance and selecting the most likely action to be responsive to that intent. For example, if the user says “find me movies starring Tom Hanks,” the expected response is a list of movies in which Tom Hanks appears. In order to provide this response, the dialog system performs a series of steps. First, the speech must be recognized as text. Next, the text must be understood and that understanding is used to select an action intended to be responsive to the command.

Existing dialog systems apply a policy that determines what action should be taken. The policy is generally a manually developed set of rules that drives the dialog system. Policy development is often an involved and time-consuming process due to the open-ended nature of dialog system design. Developing a satisfactory policy may involve exploring a limited number of alternative strategies. The rigorous testing to determine the best alternative policy is not a simple process itself. Often policies do not scale well as the complexity of the dialog system increases and the number of constraints that must be evaluated to determine the best action grows. Additionally, as the dialog system complexity increases, crafting a policy that anticipates the dependencies between signals and their joint effects becomes more difficult. Finally, the policy is a fixed rule set that does not typically allow the system to adapt. In other words, a rule that initially generates a bad result will consistently generate the same bad result as long as the policy is in place.

Some conventional dialog systems employ reinforcement learning in an effort to optimize the rule set. Reinforcement learning is a light supervision technique that operates by providing feedback regarding the success or failure of a dialog session. Reinforcement learning determines the “best” machine action sequence in a dialog session by maximizing the cumulative reward. This machine action can then be favored in future sessions. However, reinforcement learning is not a discriminative learning framework, and as such, its performance is limited because the possibilities for the “best” machine action in session are constrained by the quality of the initial rules.

It is with respect to these and other considerations that the present invention has been made. Although relatively specific problems have been discussed, it should be understood that the embodiments disclosed herein should not be limited to solving the specific problems identified in the background.

### BRIEF SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Embodiments described in the present disclosure provide a dialog system for developing and utilizing a discriminative model-based policy. When the user speaks, the speech recognizer receives and translates the utterances into text using appropriate audio processing techniques. The text is machine readable data that is processed by the language understanding module. The language understanding module decodes the text into semantic representations that may be understood and processed by the dialog manager. The semantic representation is passed to the dialog manager. The dialog manager may perform additional contextual processing to refine the semantic representation.

In the dialog manager, a dialog state prefetch module collects signals containing information associated with the current utterances from the automatic speech recognizer, the language understanding module, and the knowledge source. A dialog state update module adds some or all of the information collected by the dialog state prefetch module to the dialog session data and/or updates the dialog session data as appropriate. A machine action selection module selects the “best” or most appropriate machine action for the current dialog state based on the policies of the dialog system. The initial policy may be a rule-based policy provided for the purpose of basic operation of the dialog system and training of a discriminative model-based policy. Human annotators add annotations to the dialog session data collected using the initial rule-based policy. A training engine builds a statistical model for machine action selection (i.e., the discriminative model-based policy) based on the fully-supervised annotated dialog data. The discriminative model-based policy learns the “best” or most appropriate machine action for each dialog state from the labeled annotations.

The discriminative model-based policy is supplied to the dialog system for use as the machine action selection policy. Functionally, the discriminative model-based policy becomes the policy for the dialog system. The discriminative model-based policy takes a set of signals collected by the dialog state prefetch module and/or dialog state update module and selects the machine action to take in response to a computer-addressed utterance. The signals contain information from the automatic speech recognizer, the language understanding module, and/or the knowledge source for the current as well as previous turns.

Once the machine action selection is complete, the dialog manager executes the machine action. The output generator generates an output communicating the response to the dialog manager. The output is passed to the output renderer for presentation to the user via one or more output devices, such as a display screen and a speaker.

### BRIEF DESCRIPTION OF THE DRAWINGS

Further features, aspects, and advantages of the present disclosure will become better understood by reference to the following figures, wherein elements are not to scale so as to more clearly show the details and wherein like reference numbers indicate like elements throughout the several views:

FIG. 1 illustrates one embodiment of a dialog system employing a trainable discriminative model-based policy;

FIG. 2 is a block diagram of one embodiment of the dialog system;

FIG. 3 is a high level flowchart of one embodiment of the discriminative action selection method (i.e., the machine action selection decoding stage) performed by the dialog system;

FIGS. 4A and 4B are a high level flowchart of one embodiment of the discriminative action selection method (i.e., the machine action selection training stage) performed by the dialog system;

FIG. 5 is a block diagram illustrating one embodiment of the physical components of a computing device with which embodiments of the invention may be practiced;

FIGS. 6A and 6B are simplified block diagrams of a mobile computing device with which embodiments of the present invention may be practiced; and

FIG. 7 is a simplified block diagram of a distributed computing system in which embodiments of the present invention may be practiced.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems, or devices. Accordingly, embodiments may take the form of a hardware implementation, an entirely software implementation or an implementation combining software and hardware aspects. The following detailed description is, therefore, not to be taken in a limiting sense.

Embodiments of a dialog system employing a discriminative machine action selection solution based on a trainable machine action selection model (i.e., discriminative model-based policy) are described herein and illustrated in the accompanying figures. The discriminative machine action selection solution includes a training stage that builds the discriminative model-based policy and a decoding stage that uses the discriminative model-based policy to predict the machine action that best matches the dialog state. Data from an existing dialog session is annotated with a dialog state and an action assigned to the dialog state. The labeled data is used to train the machine action selection model. The machine action selection model becomes the policy for the dialog system used to select the machine action for a given dialog state.

The present invention is applicable to a wide variety of dialog system modalities, both input and output, such as speech, text, touch, gesture, and combinations thereof (e.g., multi-mode systems accepting two or more different types of inputs or outputs or different input and output types). Embodiments describing a spoken dialog system listening to utterances are merely illustrative of one suitable implementation and should not be construed as limiting the scope to speech modalities or a single modality. References to any modality-specific dialog system (e.g., a spoken dialog system) or inputs (i.e., utterances) should be read broadly to encompass other modalities or inputs along with the corresponding hardware and/or software modifications to implement other modalities. As used herein, the term “utterances” should be read to encompass any type of conversational input including, but not limited to, speech, text entry, touch, and gestures.

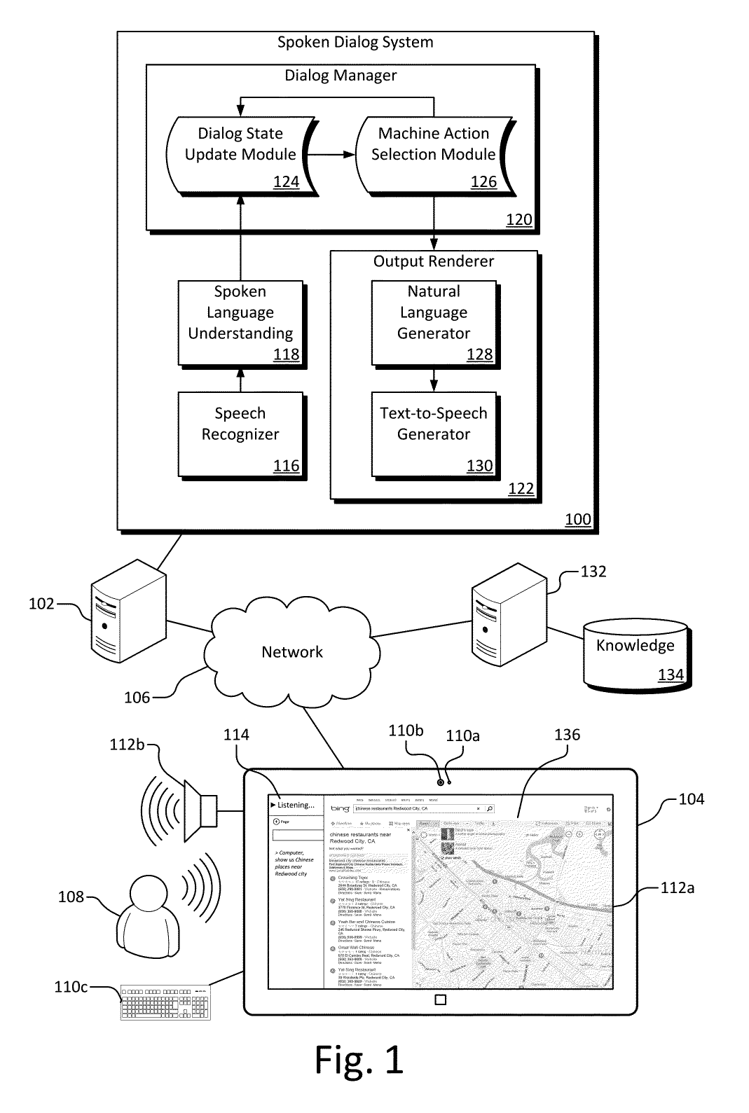

FIG. 1 illustrates one embodiment of a dialog system employing a trainable discriminative model-based policy. In the illustrated embodiment, a dialog system 100 runs on a computing device 102 in communication with a client device 104 that interfaces with the dialog system. In some embodiments, the computing device and the client device are implemented in a single computing device. For purposes of the discussion, the computing device and the client device are described as separate devices. In various embodiments, the computing device and the client device are in communication via a network 106, such as a local area network, a wide area network, or the Internet.

The client device includes one or more input devices that collect speech and, optionally, additional inputs from a user 108. At a minimum, the client device includes an audio input transducer 110a (e.g., a microphone) that records the speech of the users. The client device may optionally include a video input device 110b (e.g., a camera) to capture gestures by the user or a tactile input device 110c (e.g., a touch screen, button, keyboard, or mouse) to receive manual inputs from the user. The various input devices may be separate components or integrated into a single unit (e.g., a Kinect® sensor). The client device may also include one or more output devices including, but not limited to a display screen 112a and an audio output transducer 112b (e.g., a speaker). In various embodiments, the client device runs a user agent 114 that provides a user interface for the dialog system. In some embodiments, the user agent is a general purpose application (e.g., a web browser) or operating system. In some embodiments, the user agent is a special purpose or dedicated application (e.g., a shopping client, movie database, or restaurant rating application). The client device may be, but is not limited to, a general purpose computing device, such as a laptop or desktop computer, a tablet or surface computing device, a smart phone or other communication device, a smart appliance (e.g., a television, DVD player, or Blu-Ray player), or a video game system (e.g., Xbox 360® or Xbox One™).

The speech recorded by the audio input device and any additional information (i.e., gestures or direct inputs) collected by other input devices is passed to the dialog system. The dialog system includes a speech recognizer 116, a language understanding module 118, a dialog manager 120, and an output generator 122. The speech recognizer translates the user's speech (i.e., utterances) into machine readable data (i.e., text). The language understanding module semantically processes the machine readable data into a form that is actionable by the dialog system.

The dialog manager is a stateful component of the dialog system that is ultimately responsible for the flow of the dialog (i.e., conversation). The dialog manager keeps track of the conversation by updating the dialog session data to reflect the current dialog state, controls the flow of the conversation, performs actions based on the user requests (i.e., commands), and generates responses based on the user's requests. The dialog state is a data set that may store any and all aspects of the interaction between the user and the dialog system. A dialog state update module 124 in the dialog manager collects the dialog session data. The types and amount of dialog state information stored by the dialog state update module may vary based on the design and complexity of the dialog system. For example, some of the basic dialog state information stored by most dialog systems includes, but is not limited to, the utterance history, the last command from the user, and the last machine action.

A dialog policy provides a logical framework that guides the operation of the dialog manager. The dialog policy may include multiple policies. At least one of the dialog policies is a discriminative model-based policy built from supervised dialog session data annotated with a dialog state and a machine action assigned to that dialog state. In various embodiments, the annotated dialog session data is fully supervised.

A discriminative machine action selection module 126 selects a machine action for responding to the user requests based on the model-based policy given the current dialog state. Examples of machine actions include, but are not limited to, executing an informational query against a knowledgebase or other data system (e.g., get a list of recent movies of a selected genre staring a selected actor from a movie database), executing a transactional query to invoke a supported application (e.g., play a media file using a supported media player or submit a query to web search engine using a supported web browser), and executing a navigational query (e.g., start over or go back) against the dialog system to navigate through the dialog state.

Once selected the machine action is executed and the result, if any, is collected for use in the response. The output generator generates an output communicating the response of the dialog system, which may be presented to the users via the user agent. Depending upon the machine action, the response may be in the form of a collection of responsive information to an informational query (e.g., list of movies, videos, songs, albums, flights, or hotels), the presentation of specific content (e.g., playing a selected movie, video, song, album, or playlist), returning to a previous result, or the like. In some embodiments, the response may be a command that will be executed by the client device. For example, the response may be a command to invoke a specific application to play the selected content along with a resource locator (i.e., an address) for the content. In some embodiments, the output generator includes an optional natural language generation component 128 that converts the response into natural (i.e., human) sounding text for presentation to the users. In some embodiments, the output generator includes an optional text-to-speech component 130 that translates the natural language output into speech and allows the speech dialog system to verbally interact with the users. The output is rendered to the user via one or more of the output devices of the client device.

In various embodiments, the dialog system is in communication with a knowledge source 132 and/or supported application 134 that are referenced or invoked by the selected machine action. The knowledge source provides knowledge 136 (i.e., content and/or information) for the domains supported by the dialog system and may be internal (e.g., a backend system) or external (e.g., a third party knowledgebase) to the dialog system. In various embodiments, the knowledge source may be in communication with the computing device and/or the interface device via the network. In some embodiments, the dialog system and the knowledge sources are implemented in a single computing device. In other embodiments, the dialog system and the knowledge source may be distributed across various computing devices. In the illustrated embodiment, the knowledge source is represented by an external knowledge system. Examples of external knowledge sources include, but are not limited to, online store fronts, online movie databases, online encyclopedias, and search engines. Likewise, the supported application acts on content for the domains handled by the dialog system and may be internal or external to the dialog system or the user agent. Although referred to in the singular, more than one knowledge source and/or supported application may be used depending upon factors such as, but not limited to, the number of domains and content types handled by the dialog system.

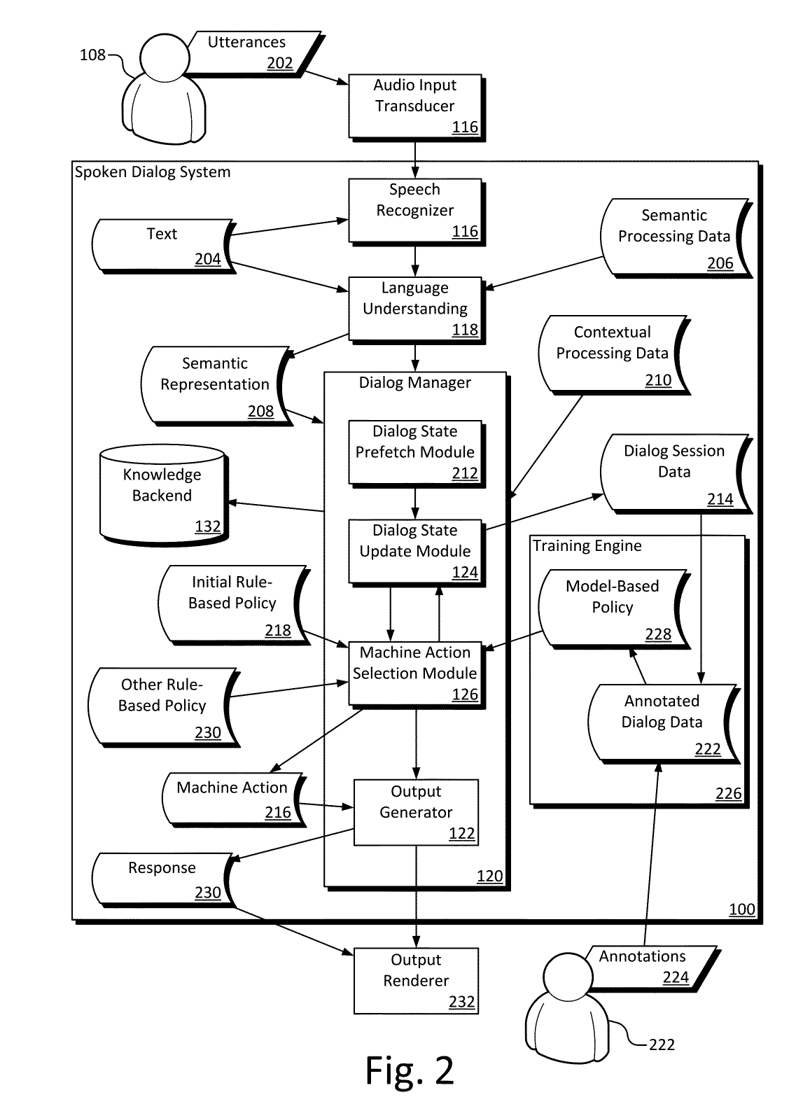

FIG. 2 is a flow diagram of one embodiment of the dialog system for developing and utilizing the discriminative model-based policy for machine action selection. When the user speaks, the speech recognizer receives and translates the utterances 202 into text 204 using appropriate audio processing techniques. The text is machine readable data that is processed by the language understanding module. The language understanding module may utilize semantic processing data 206 to disassemble, parse, and convert the text into semantic representations 208 that may be understood and processed by the dialog manager. More specifically, the language understanding module estimates the intent of the computer-addressed utterance, selects a semantic frame associated with the intent, and maps the entities (i.e., values) extracted from the utterances to the corresponding slots in the selected semantic frame.

The semantic processing data may include, but is not limited to, domain classification models, topic segmentation models, feature extraction models, and semantic ontologies used to implement various semantic decoder methodologies to determine aspects such as the domain, intent, and semantic frames corresponding to the text. For example, the language understanding module may decode the text based on word strings in an N-best list or a word lattice. Examples of intents include, but are not limited to, start over, go back, find information, find content, and play content. The semantic frame typically involves a schema of domain-specific slot type/value pairs. By way of example, a semantic frame to find information in a domain may be defined as Find_Information (<domain>, <slot tag>, <slot value>) or Find_<domain>(<slot tag>, <slot value>). Examples of domains include, but are not limited to, movies, music, books, restaurants, flights, and hotels. Examples of domain-specific slot types include, but are not limited to, director, actor, genre, release date, and rating for the movie domain and restaurant name, cuisine, restaurant location, address, phone number, and service type for the restaurant domain. The determinations may be made based solely on the text associated with the current utterance or may take the text associated with prior utterances into consideration as well.

The semantic representation and, optionally, other supporting or underlying information (e.g., the original text) is passed to the dialog manager. The dialog manager may perform additional contextual processing to refine the semantic representation based on contextual processing data 210. For example, in the illustrated embodiment, the dialog manager may apply a powerset of the N-best list or the word lattice to the text to update the semantic representation; however, other types of contextual processing data may be used.

A dialog state prefetch module 212 collects signals containing information from the automatic speech recognizer, the language understanding module, and the knowledge source associated with the current utterances. Information collected from the automatic speech recognizer may include, but is not limited to, the text associated with the utterances. Information collected from the language understanding module may include, but is not limited to, the domains, the semantic representations, the intent, the slot types, and the slot values associated with the utterances. Information collected from the knowledge source may include, but is not limited to, the predicted number of results and/or the actual results for informational queries associated with the utterances. In the illustrated embodiment, the knowledge source is represented by a knowledge backend that is integral with the dialog system. The dialog state update module adds some or all of the information collected by the dialog state prefetch module to the dialog session data and/or updates the dialog session data 214 as appropriate.

As previously mentioned, the machine action selection module 126 selects a machine action 216 for the current dialog state based on the policies of the dialog system. The initial policy may be a rule-based policy 218 provided for basic operation of the dialog system and training of a discriminative model-based policy. After a significant amount of data has been collected, the dialog session data is manually annotated by human annotators 220 to create a fully-supervised annotated dialog data set 222. The human annotators review the dialog session data, evaluate the dialog state, select the most appropriate machine action for the dialog state, and add annotations 224 such as, but not limited to, data pairs that describe the dialog state and the most appropriate machine action for that dialog state as determined by the human annotator. The annotations may also include a score assigned to each possible machine action for one or more N-best alternatives. Each N-best alternative corresponds to a separate knowledge result. Typically, the amount dialog session data needed to create the annotated dialog session that is suitable for training the discriminative model-based policy is several thousand turns (i.e., utterances). For example, a minimum amount of data collected may be approximately 5,000 turns or approximately 10,000 turns.

A training engine 226, which may be internal or external to the dialog system, builds the discriminative model-based policy 228 based on the annotated dialog data by applying one or more machine learning techniques. Examples of suitable machine learning techniques include, but are not limited to, conditional random fields (CRFs), boosting, maximum entropy modeling (MaxEnt), support vector machines (SVMs), and neural networks (NNet). Examples of suitable training engines include, but are not limited to, icsiboost, and Boostexter, and Adaboost. The discriminative model-based policy learns the “best” or most appropriate machine action for each dialog state from the labeled annotations. In various embodiments, the “best” machine action is the most probable machine action for a given dialog state or the machine action with the highest score out of a set of possible machine actions.

Once trained, the discriminative model-based policy is supplied to the dialog system for use as the machine action selection policy. Functionally the discriminative model-based policy becomes the policy for the dialog system. The discriminative model-based policy may operate in place of (i.e., replace) or in conjunction with (i.e., supplement) the rule-based policy. The discriminative model-based policy is a statistical machine action selection model that generates a score (e.g., probabilities) for each machine action given the dialog state. In other words, the discriminative model-based policy maps machine actions to dialog states. The discriminative model-based policy may encompass both context-based machine action selection and business logic. Alternatively, the business logic is embodied in a different policy from a discriminative model-based policy primarily controlling context-based machine action selection.

Examples of machine actions include, but are not limited to, executing an informational query against a knowledgebase or other data system (e.g., get a list of recent movies of a selected genre staring a selected actor from a movie database), executing a transactional query to invoke a supported application (e.g., play a media file using a supported media player or submit a query to web search engine using a supported web browser), and executing a navigational query (e.g., start over or go back) against the dialog system to navigate through the dialog state. The discriminative model-based policy takes a set of signals collected by the dialog state prefetch module and/or dialog state update module and selects the machine action to take in response to a computer-addressed utterance. The signals contain information from the automatic speech recognizer, the language understanding module, and/or the knowledge source for the current turn and, optionally, for previous turns as well.

The dialog system may have more than one policy that controls the selection of the machine action. In the illustrated embodiment, a supplemental rule-based policy 230 is provided. The supplemental rule-based policy may define a set of rules implementing business or call-flow logic and/or priorities that may modify or override the machine action selection policy in various situations. For convenience, the business and call-flow logic and/or priorities are collectively to as business logic. Maintaining separation between the context-based machine action selection policy and the business logic allows the business logic to be easily changed without requiring retraining of a combined policy model.

Once the machine action selection is complete, the dialog manager executes the machine action. The output generator generates an output used to communicate the response to the selected machine action to the user. The output is passed to the output renderer 232 for presentation to the user via one or more output devices, such as a display screen and a speaker.

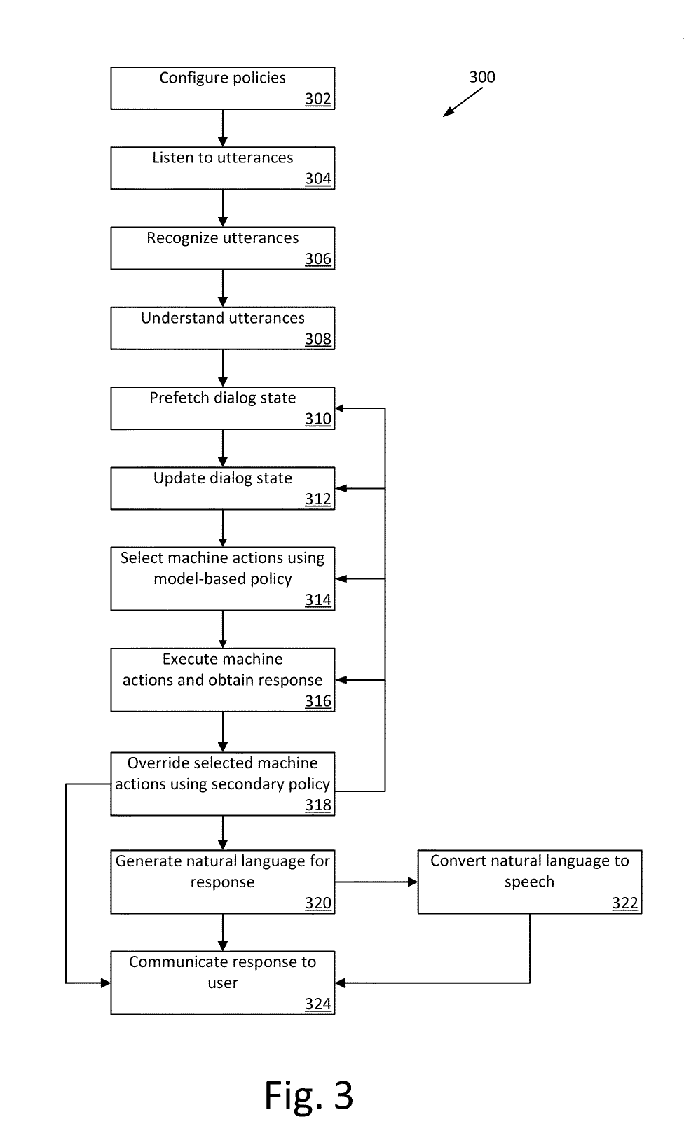

FIG. 3 is a high level flowchart of one embodiment of the discriminative action selection method (i.e., the machine action selection decoding stage) performed by the dialog system. The discriminative action selection method 300 begins with a policy configuration operation 302 in which the dialog system receives the discriminative model-based policy statistically linking machine actions to dialog states. In some embodiments, the dialog system also receives a business logic policy specifying a set of business rules used to select machine actions based on specified criteria or to otherwise control the flow of the dialog. The business logic policy may include rules that are not context-based and may be used to override a context-based machine action selection. The business logic policy may have been previously provided during the training policy configuration operation.

During a listening operation 304, the dialog system records the utterances of the users along with any additional information (i.e., gestures or direct inputs) associated with the utterances. A speech recognition operation 306 transcribes utterances (i.e., speech) to text.

A language understanding operation 308 estimates the meaning of utterance. More specifically, the language understanding operation parses the text and converts the text into a semantic representation of the estimated intent and the associated entities (i.e., values) to fill the slots associated with the intent. In multi-domain dialog system, the language understanding operation also determines the domain of the current computer-addressed utterance.

A dialog state prefetch operation 310 collects signals containing information from the automatic speech recognizer, the language understanding module, and the knowledge source associated with the current utterances. Information collected from the automatic speech recognizer may include, but is not limited to, the text associated with the utterances. Information collected from the language understanding module may include, but is not limited to, the domains, the semantic representations, the intent, the slot types, and the slot values associated with the utterances. Information collected from the knowledge source may include, but is not limited to, the predicted number of results and/or the actual results for informational queries associated with the utterances. A dialog state update operation 312 adds some or all of the information collected by the dialog state prefetch operation to the dialog session data and/or updates the dialog session data as appropriate.

The machine action selection operation 314 determines the most appropriate machine action to satisfy the estimated intent based on the current dialog state. In various embodiments, the determination involves identifying the possible machine actions for the current dialog state, determining the score for the possible machine actions, and selecting the “best” or most appropriate machine action based on the scores. For example, the most appropriate machine action may be the machine action having the highest score (e.g., probability). The determination may also involve some context-based processing of the text and or the semantic representation for such purposes as to resolve ambiguities (i.e., disambiguation), collect additional information, or incorporate context from prior turns.

The machine actions selected by the machine action selection operation may be high-level, communicative actions such as, but not limited to, confirm, play, request-info, and show-info. In various embodiments, the selected machine action is a summarized action with arguments. The arguments may specify criteria such as, but not limited to, machine action targets, best knowledge results, error conditions, and disambiguating characteristics. For example, instead of a specific action like confirmplaybatman or confirmplayavatar, the summarized action returned by machine action selection operation may be confirmplay(<mediafile>) using slot values to provide the value for the arguments (i.e., <mediafile>=“Batman” or “Avatar”).

Following the machine action selection operation, a machine action execution operation 316 executes the selected machine action to satisfy the intent associated with the utterance (i.e., the user's request). Informational queries (e.g., find the movies of a certain genre and director) may be executed against knowledge repositories, transactional queries (e.g., play movie) may be executed against supported applications and/or media, and command queries (go back to the previous results) may be executed against the dialog system to navigate through the dialog.

An action override operation 318 may apply the business logic policy to augment or override the selected machine action in order to meet selected goals by controlling the dialog flow. For example, a selected machine action of the informational query type may return no results (i.e., no data satisfied the query). In such a case, one option is for the dialog system to indicate that no results were found and switch to a system initiative mode asking the user to modify the query. The business logic policy may dictate that an informational query should always return some results and not require the user to modify the query. Accordingly, the business logic override operation would automatically modify the query by dropping slot values until a non-zero result set is predicted or returned. The business logic override operation may occur before or after the machine action execution operation and typically prior to displaying the result of the machine action. In the above example, the business logic override operation may occur prior to the machine action execution operation based on the predicted results. Alternatively, the business logic override operation may occur after the machine action execution operation based on the actual results necessitating the machine action execution operation to repeat using the modified query. Another example of a business logic override operation is to determine an appropriate targeted advertisement and inject it into the query results.

The dialog manager may repeat one or more of the dialog state prefetch, dialog state update, machine action selection, machine action execution, and/or business logic override operations until an appropriate machine action is selected and satisfactory results are obtained. An optional natural language generation operation 320 generates a text-based response in natural language. An optional text-to-speech operation 322 generates a computer voice that speaks to the user. For example, the text-to-speech operation speaks the text of the natural language response in addition to or in lieu of displaying the text of the natural language response. Finally, an output operation 324 renders and communicates the results of the machine action to the user.

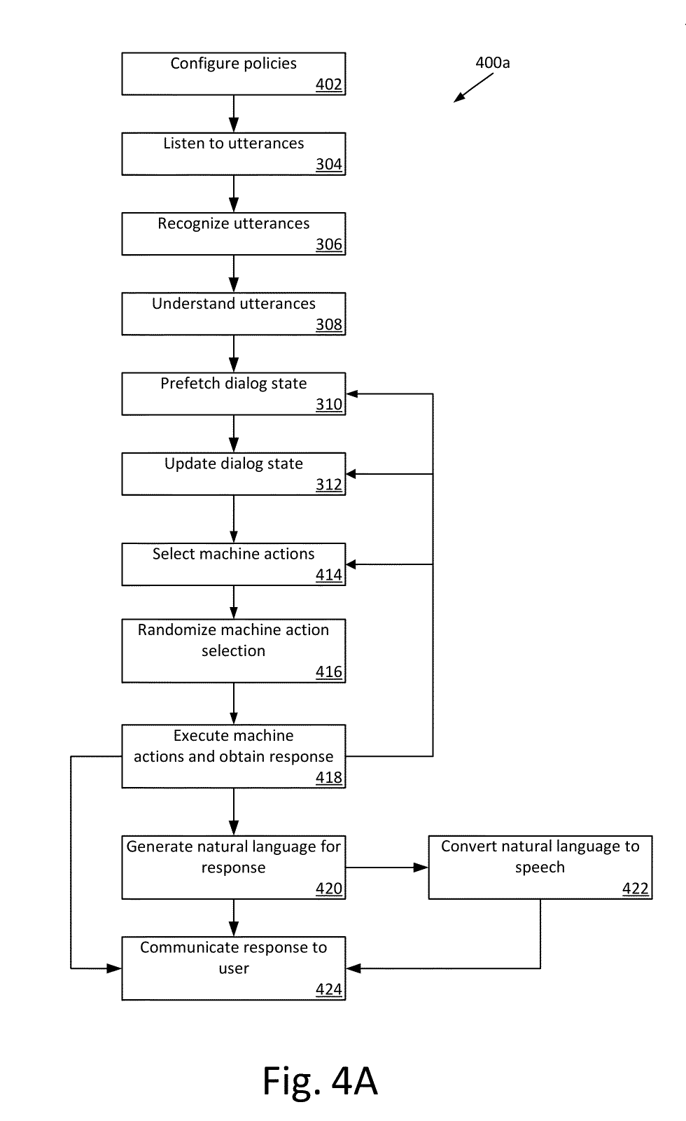

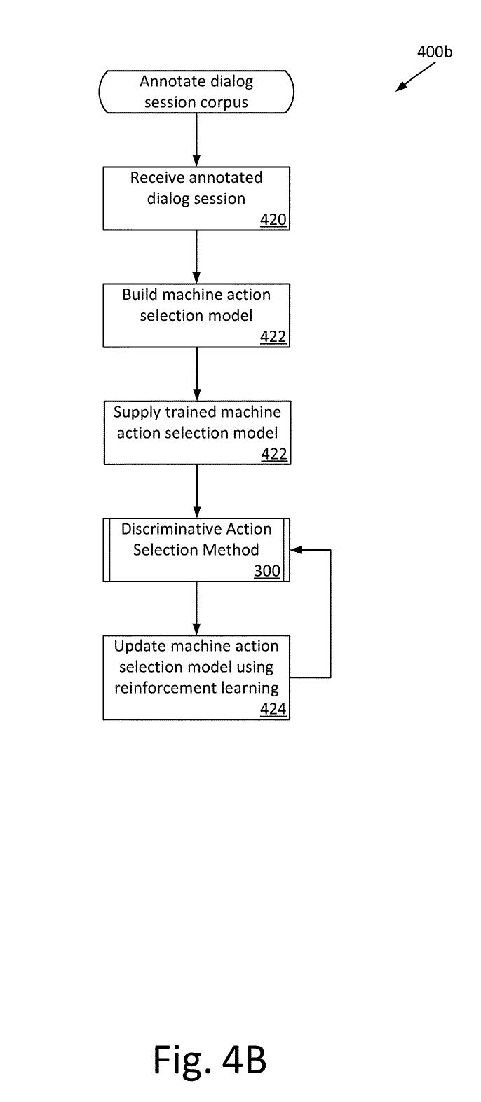

FIGS. 4A and 4B is a high level flowchart of one embodiment of the discriminative policy training method (i.e., the machine action selection training stage) performed by the dialog system. FIG. 4A deals primarily with the collection of training data uses to build the discriminative model-based policy. The discriminative policy training method 400a begins with initial configuration operation 402 in which the dialog system initially receives a training policy. The training policy is a set of rules that determines the machine action based on certain conditions. The training policy may be a hand-crafted set of rules and may incorporate context-based rules and/or business logic. The discriminative policy training method shares some of the same basic operations with the discriminative action selection method such as the listening operation 304 recording utterances from the user, the speech recognition operation 306 transcribing the utterances to text, the language understanding operation 308 estimating the meaning of utterance, the dialog state prefetch operation 310 collecting signals containing information from the automatic speech recognizer, the language understanding module, and the knowledge source, and the dialog state update operation 312 adding to and/or updating the dialog session data with the current dialog state. The information collected by the dialog state prefetch operation and/or stored by the dialog state update operation of the discriminative action training method may differ from the information collected and stored by the corresponding operations of the discriminative policy selection method.

The machine action selection operation 414 determines the most appropriate machine action to satisfy the estimated intent based on the current dialog state. In general, the machine action selection operations of the discriminative policy training method and the discriminative action selection method are similar. One significant difference is that, in the discriminative policy training method, the machine action selection operation selects machine actions based on the initial rule-based policy or other training policy. In some embodiments, machine actions may be selected based on the training policy and a previously trained discriminative model-based policy.

An optional randomization operation 416 randomizes the action selected by the training policy for a certain percentage of utterances. In various embodiments, the selected percentage is approximately 10%; however, other percentages may be used. The randomization operation adds diversity to the dialog session corpus by causing different machine actions to be selected for some occurrences of the same or similar dialog state. The randomization may be introduced by specific rules in the training policy that randomly select one of a number of possible machine actions for a given dialog state. In other words, the training policy is crafted so that the “best” machine action for a given dialog state is not always selected. Alternatively, embodiments of the dialog manger may execute a special training mode that randomly overrides the training policy used while developing the dialog session corpus.

One reason for the randomization operation is that the user inputs depend on the response of the system at the previous turn. When training or modifying a model, especially using off-line (i.e., previously recorded) data such as the dialog session corpus, the data cannot respond to changes in the model. In other words, the data from the dialog session corpus obtained using one policy (e.g., the training policy) does not coincide with the data that would be obtained using a different (i.e., modified) policy if it had been the one in place when the data was collected. Having the dialog system make random decisions, including machine action selection decisions, causes the exploration of alternative dialog paths. Exploration makes the dialog session corpus richer (i.e., adds diversity) because the resulting dialog session corpus will not be strictly limited to the constraints of the training policy. In many cases, the data from the richer dialog session corpus has greater reusability. Further, always selecting certain actions for certain dialog states does not fully explore the consequences of selecting other actions that are determined to be less appropriate based on the training policy. The user will react to these random machine actions, providing additional information for use in building the discriminative model-based policy that might not be explored otherwise. Even when the randomly selected machine action is incorrect, seeing the user's reaction and how the dialog system recovers provides valuable information when building the discriminative model-based policy.

FIG. 4B shows the portion of the discriminative policy training method 400b focusing on the training of the discriminative action selection model. Once the dialog session data contains a sufficient amount of data (i.e., number of turns), the dialog session corpus is annotated by the human annotators, as previously described, and supplied to the training engine. The annotations may optionally be applied to none, some, or all portions of the dialog session where the machine action is dictated by supplemental policies (e.g., business or call-flow rules) depending upon the desired amount of separation between the policies.

The training engine receives the annotated dialog session data in a training data receipt operation 418. The training operation 420 performed by the training engine builds the discriminative model-based policy by applying machine learning techniques to the annotated dialog session. During a trained model supply operation 422, the training engine supplies the trained discriminative model-based policy to the dialog system. This effectively integrates the discriminative policy training method with the discriminative action selection method training at the policy configuration operation 302. In an optional reinforcement learning operation 424, the dialog system trains an alternative policy using the scores generated by the discriminative model-based policy as more granular and discriminative rewards during reinforcement learning.

The subject matter of this application may be practiced in a variety of embodiments as systems, devices, and other articles of manufacture or as methods. Embodiments may be implemented as hardware, software, computer readable media, or a combination thereof. The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

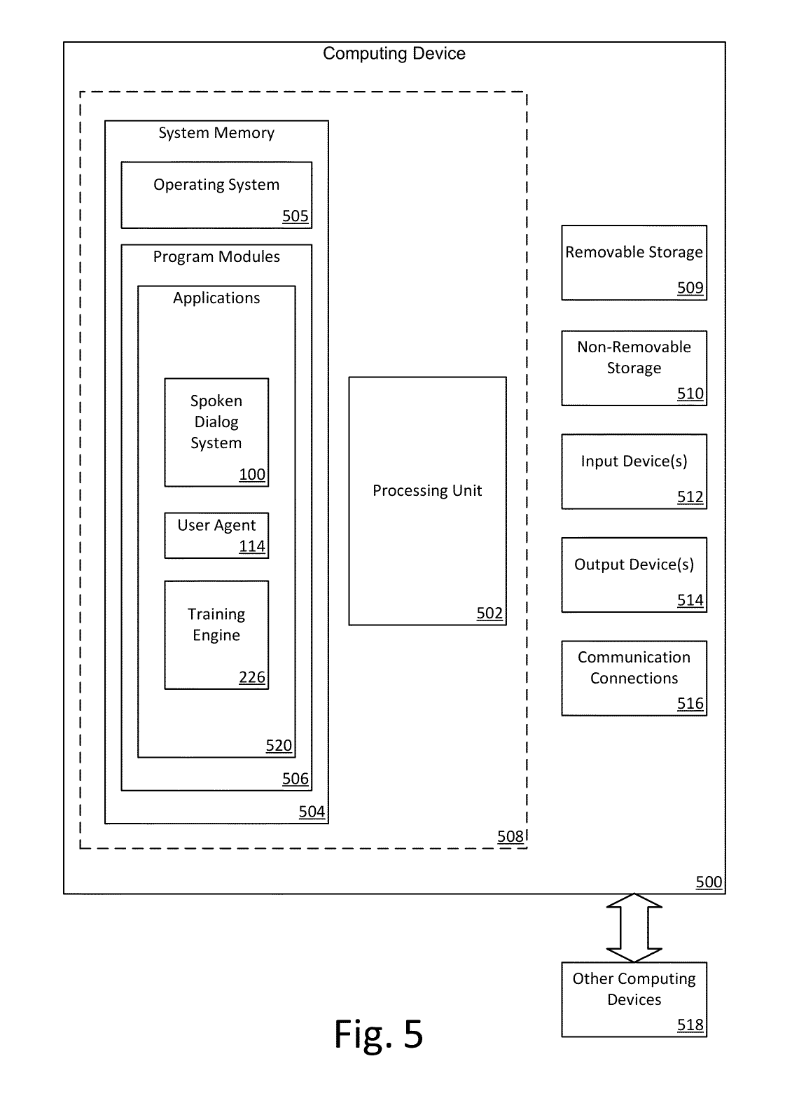

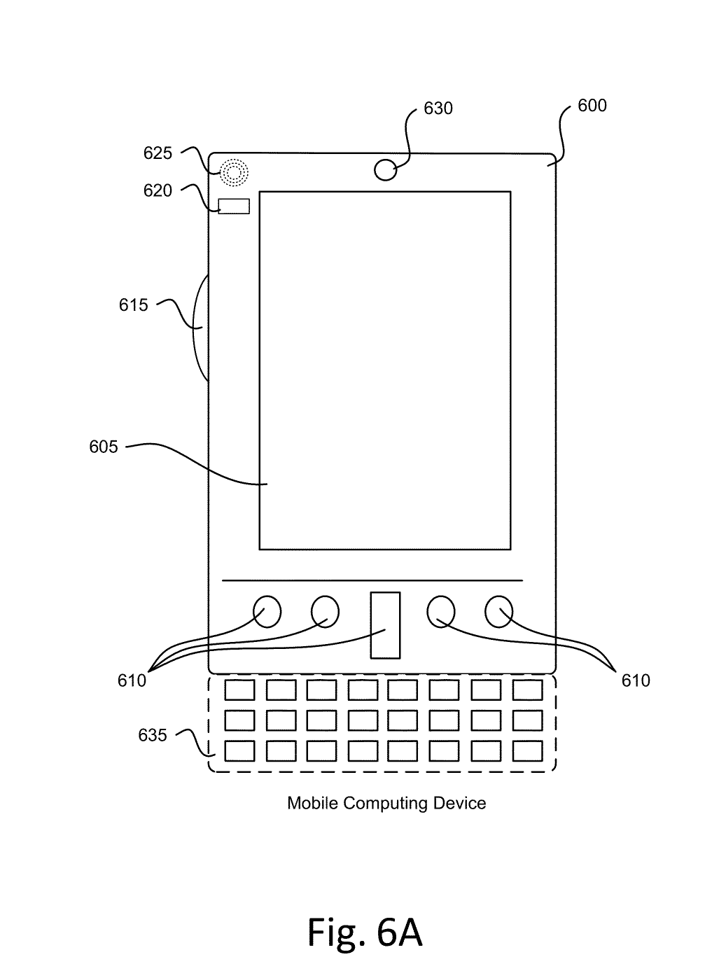

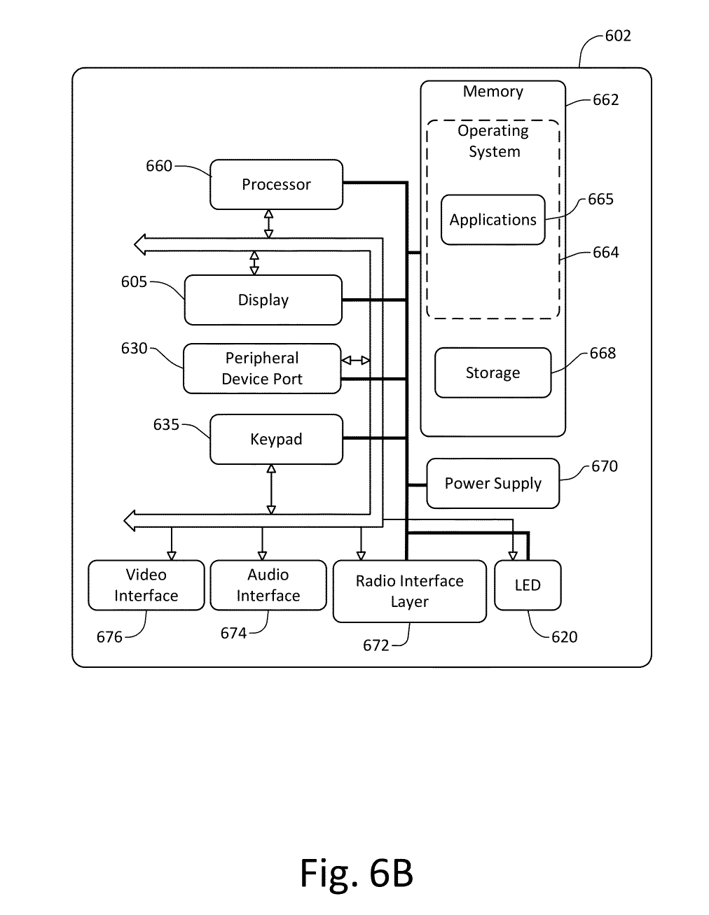

FIGS. 5 and 6 and the associated descriptions provide a discussion of a variety of operating environments in which embodiments of the invention may be practiced. However, the devices and systems illustrated and discussed are for purposes of example and illustration and are not limiting of a vast number of computing device configurations that may be utilized for practicing embodiments of the invention described above.

FIG. 5 is a block diagram illustrating physical components (i.e., hardware) of a computing device 500 with which embodiments of the invention may be practiced. The computing device components described below may be suitable for embodying computing devices including, but not limited to, a personal computer, a tablet computer, a surface computer, and a smart phone, or any other computing device discussed herein. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 505 and one or more program modules 506 suitable for running software applications 520 such as the dialog system 100, the user agent 114, and the training engine 226. For example, the operating system 505 may be suitable for controlling the operation of the computing device 500. Furthermore, embodiments of the invention may be practiced in conjunction with a graphics library, other operating systems, or any other application program and is not limited to any particular application or system. This basic configuration is illustrated by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated by a removable storage device 509 and a non-removable storage device 510.

As stated above, a number of program modules and data files may be stored in the system memory 504. While executing on the processing unit 502, the software applications 520 may perform processes including, but not limited to, one or more of the stages of the discriminative action selection method 300 or the discriminative policy training method 400a-b. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the illustrated components may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein with respect to the software applications 520 may be operated via application-specific logic integrated with other components of the computing device 500 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 500 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used. The computing device 500 may include one or more communication connections 516 allowing communications with other computing devices 518. Examples of suitable communication connections 516 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all examples of computer storage media (i.e., memory storage.) Computer storage media may include random access memory (RAM), read only memory (ROM), electrically erasable read-only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500.

FIGS. 6A and 6B illustrate a mobile computing device 600 with which embodiments of the invention may be practiced. Examples of suitable mobile computing devices include, but are not limited to, a mobile telephone, a smart phone, a tablet computer, a surface computer, and a laptop computer. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative embodiments, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface, a visual indicator 620 (e.g., a light emitting diode), and/or an audio transducer 625 (e.g., a speaker). In some embodiments, the mobile computing device 600 incorporates a vibration transducer for providing the user with tactile feedback. In yet another embodiment, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one embodiment of a mobile computing device. That is, the mobile computing device 600 can incorporate a system (i.e., an architecture) 602 to implement some embodiments. In one embodiment, the system 602 is implemented as a smart phone capable of running one or more applications (e.g., browsers, e-mail clients, notes, contact managers, messaging clients, games, and media clients/players). In some embodiments, the system 602 is integrated as a computing device, such as an integrated personal digital assistant (PDA) and wireless phone.

One or more application programs 665 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 665 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600, including software applications 520 described herein.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the outside world via a communications carrier or service provider. Transmissions to and from the radio 672 are conducted under control of the operating system 664. In other words, communications received by the radio 672 may be disseminated to the application programs 665 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present invention, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

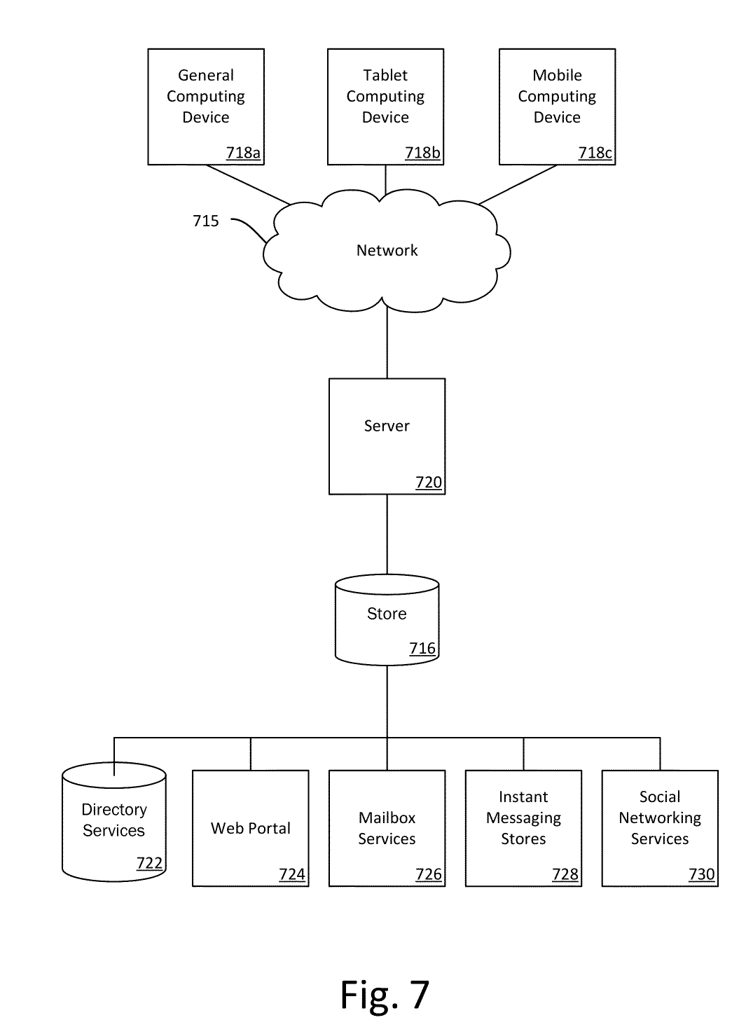

FIG. 7 illustrates one embodiment of the architecture of a system for providing dialog system functionality to one or more client devices, as described above. Content developed, interacted with, or edited in association with the software applications 520 may be stored in different communication channels or other storage types. For example, various documents may be stored using a directory service 722, a web portal 724, a mailbox service 726, an instant messaging store 728, or a social networking site 730. The software applications 520 may use any of these types of systems or the like for enabling data utilization, as described herein. A server 720 may provide the software applications 520 to clients. As one example, the server 720 may be a web server providing the software applications 520 over the web. The server 720 may provide the software applications 520 over the web to clients through a network 715. By way of example, the client computing device may be implemented as the computing device 500 and embodied in a personal computer 718a, a tablet computer 718b, and/or a mobile computing device (e.g., a smart phone) 718c. Any of these embodiments of the client device 104 may obtain content from the store 716.

The description and illustration of one or more embodiments provided in this application are intended to provide a complete thorough and complete disclosure the full scope of the subject matter to those skilled in the art and not intended to limit or restrict the scope of the invention as claimed in any way. The embodiments, examples, and details provided in this application are considered sufficient to convey possession and enable those skilled in the art to practice the best mode of claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A method of selecting machine actions in a dialog system using a discriminative model-based policy, the method comprising the acts of:
receiving the discriminative model-based policy statistically linking machine actions to dialog states;
collecting a utterance from a user;
determining a meaning for the utterance;
updating a session dialog state based on the utterance;
selecting the machine action based on the discriminative model-based policy and the session dialog state;
executing the machine action; and
outputting the results of the machine action for presentation to the user.

2. The method of claim 1 further comprising the acts of:
receiving a training policy comprising a set of rules prior to the act of receiving a discriminative model-based policy statistically linking machine actions to dialog states;
receiving a plurality of utterances;
recognizing the plurality of utterances as text;
selecting machine actions for the plurality of utterances based on the training policy;
collecting the text and the corresponding machine actions in a dialog session corpus;
receiving an annotated dialog session based on the dialog session corpus; and
training the discriminative model-based policy from the annotated dialog session.

3. The method of claim 2 further comprising the act of replacing the training policy with the discriminative model-based policy.

4. The method of claim 2 wherein the annotations comprise a plurality of annotation pairs, each annotation pair comprising a dialog state and a machine action assigned to the dialog state based on the current context of the dialog session corpus.

5. The method of claim 2 wherein the annotations comprise a score assigned to each possible machine action for at least one N-best alternative.

6. The method of claim 2 further comprising the act of randomizing the training policy for selected percentage of utterances whereby different machine actions are selected and added to the dialog session corpus.

7. The method of claim 2 wherein the act of training the discriminative model-based policy from the annotated dialog session further comprises the act of applying machine learning techniques to train a statistical model that generates a score for each machine action given the dialog state.

8. The method of claim 7 further comprising the act of using the scores generated by the discriminative model-based policy as rewards when training an alternative policy with reinforcement learning.

9. The method of claim 1 further comprising the acts of:
generating a set of signals containing information associated with the utterance from at least one of an automatic speech recognizer, a language understanding module, and a knowledge source associated with the utterance;
updating the dialog state with the set of signals; and
selecting a machine action based on a score generated for the machine action given the current dialog state using the discriminative model-based policy.

10. The method of claim 1 further comprising the acts of:
receiving a business logic policy comprising a set of business rules; and
overriding the selected machine action based on one of the business rules.

11. A dialog system using a discriminative model-based policy for machine action selection, the dialog system comprising:
an input device collecting utterances from a user as text;
a language understanding module generating semantic representations of the text;
a dialog state memory storing dialog session data;
a dialog state update module collecting information from at least one of the input device and the language understanding module and updating the dialog session data;
a discriminative model-based policy statistically relating machine actions to dialog states;
a machine action selection module selecting one of machine actions for the current dialog state based on the discriminative model-based policy; and
an output renderer communicating the result of the selected machine action to the user.

12. The dialog system of claim 11 further comprising a knowledge source storing content or information associated with a selected domain, wherein the dialog state update module collects information from the knowledge source and the machine action execution module retrieves information from the knowledge source based on the selected machine action.

13. The dialog system of claim 11 further comprising a training engine building the discriminative model-based policy from labeled dialog session data annotated with dialog states and an associated machine action for each dialog state.

14. The dialog system of claim 11 wherein the discriminative model-based policy is a statistical model used to generate scores for a set of possible machine actions associated with the current dialog state, the machine action selection module using the scores to select the machine action for the current dialog state.

15. The dialog system of claim 11 further comprising a business logic policy separate from the machine action selection policy, the business logic policy selectively overriding the selected machine action.

16. The dialog system of claim 11 wherein the output renderer further comprises:
an automatic speech recognizer recognizing the utterances made by a user as text;
a natural language generator; and
a text-to-speech generator.

17. A computer readable medium containing computer executable instructions which, when executed by a computer, perform a method for selecting machine actions in a dialog system based on a discriminative model-based policy, the method comprising:
receiving a training policy comprising a set of rules prior to the act of receiving the discriminative model-based policy statistically linking machine actions to dialog states;
receiving a plurality of utterances;
recognizing the plurality of utterances as text;
selecting machine actions for the plurality of utterances based on the training policy;
collecting the text and the corresponding machine actions in a dialog session corpus;
receiving an annotated dialog session based on the dialog session corpus;
training the discriminative model-based policy statistically linking machine actions to dialog states using the annotated dialog session;
receiving the discriminative model-based policy; and
selecting machine actions for a current utterance based on the discriminative model-based policy.

18. The computer readable medium of claim 17 wherein the method further comprises the acts of:
receiving a policy mapping machine actions to business logic constraints; and
prior to outputting the results of the machine action for presentation to the user, overriding the machine action selected from the discriminative model-based policy with the machine action based on business logic.

19. The computer readable medium of claim 17 wherein the method further comprises the acts of:
determining a domain for the utterance;
determining a user intent for the utterance; and
filling at least one slot type with a slot value based on the utterance.

20. The computer readable medium of claim 19 wherein the method further comprises the act of generating a summarized action with an argument based on the slot value.
